(19) United States
(12) Patent Application Publication
(10) Pub. No.: US 2025/0266741 A1
(43) Pub. Date: Aug. 21, 2025

(54) METHOD, SYSTEM, ACTUATOR AND AIRCRAFT

(71) Applicant: Liebherr-Aerospace Lindenberg GmbH, Lindenberg (DE)

(72) Inventors: Thomas IMMLER, Sigmarszell (DE); Julian KINZELMANN, Hergensweiler (DE); Christian KOHLÖFFEL, Amtzell (DE); Christian SCHILLING, Maierhöfen (DE)

(21) Appl. No.: 19/060,349

(22) Filed: Feb. 21, 2025

(30) Foreign Application Priority Data
Feb. 21, 2024 (DE) 10 2024 104 848.4

(51) Int. Cl. H02K 11/21; B64C 13/50

(52) U.S. Cl. CPC H02K 11/21; B64C 13/50

(57) ABSTRACT

The present disclosure relates to a method for controlling and/or determining a position of an actuator, in particular of an aircraft, wherein the actuator has a control unit, a motor and a motor position sensor for determining a position of the motor, wherein the control unit controls and/or determines the position of the actuator using the position of the motor and/or a sensor signal from the motor position sensor.

### CROSS REFERENCE TO RELATED APPLICATION

The present application claims priority to German Patent Application No. 10 2024 104 848.4 filed on Feb. 21, 2024. The entire contents of the above-listed application are hereby incorporated by reference for all purposes.

### TECHNICAL FIELD

The present disclosure relates to a method for controlling and/or determining a position of an actuator, in particular of an aircraft, wherein the actuator has a control unit, a motor and a motor position sensor for determining a position of the motor.

### BACKGROUND

The trend towards the electrification of elements, functions and actuators in aviation, through the use of linear and rotary electromechanical and electrohydraulic actuators, is continuing. The advantages of electrification are realised, among other things, through more efficient and optimised control.

### SUMMARY

The increased development and use of electrically operated actuators, the wide range of technical applications, the increased service life requirements and the latest safety requirements for actuators also result in new requirements for the control, safety and monitoring concepts for future electromechanical and electrohydraulic actuators. The applications within the future concept of the “More-Electric-Aircraft” will place new demands on the components in terms of installation space, weight, availability, verifiability, safety, etc. and will become increasingly important in the future.

Control of the position of an actuator in a higher-level control system or a higher-level computer is known from the prior art, wherein the control is independent of the design of the actuator. This is used, for example, for electrohydraulic actuators (EHA) and servo actuators in the A400M or A380 aircraft models.

The position of the actuator is controlled in a higher-level controller, e.g. a flight control computer (FCC), which reads out the position of the actuator via a dedicated position sensor, e.g. a differential transformer (LVDT), and uses this position for the control. The higher-level control system calculates and commands a motor speed determined by the control system or a “servo-valve” current determined by the control system. This type of control of the position can be realised regardless of the design of the actuator. No direct connection between the position of the actuator drive, e.g. an electric motor, and the position of the actuator is necessary.

The disadvantage of this highly dynamic control system is that it requires fast data transfer between the higher-level control system and the actuator control unit or actuator control electronic (ACE).

Another disadvantage is that, depending on the criticality of the application, it may be necessary to use redundant sensors, e.g. duplex LVDT, which leads to higher costs.

As shown in FIG. 6, the command channel COM and the monitor channel MON of the higher-level control system SFCC each receive independent sensor signals to determine the position of the actuator POS from the duplex sensor PPU.

The motor M is controlled via a speed and/or torque command from the command channel COM of the higher-level control system SFCC. FIG. 6 shows the concept of a typical high-lift architecture.

It is also known to control the position of an actuator in an actuator control electronics system by means of an actuator position sensor, as is the case, for example, in known Multi-Role Tanker Transport (MRTT) aircraft models.

The position of the actuator is controlled here in an actuator control electronic (ACE), which reads out the position of the actuator via a dedicated position sensor, e.g. an LVDT, and uses this position for control.

In a disadvantageous way, redundant dedicated position sensors are necessary if the control of the position of the actuator is a critical function, which results in higher costs.

The control of the position of an actuator, in particular an electromechanical actuator, known in the prior art uses more sensors than necessary, which is unfavourable.

The control of an actuator's position on a higher-level control system known in the prior art takes too long to realise fast control of the position of an actuator. The data transfer time between the electronic components delays the control.

Against this background, the object of the present disclosure is to improve a method for controlling the position of an actuator.

This object is achieved by the method as described herein.

Therefore, according to the disclosure, it is provided that the control unit controls and/or determines the position of the actuator using the position of the motor and/or a sensor signal from the motor position sensor.

The term “control” is to be understood broadly and can mean or include both the open-loop control and also closed-loop control of a position.

It may be provided that alternatively or additionally a speed and/or an acceleration of the actuator and/or a component, in particular an actuating element, of the actuator is controlled.

A position of the motor can be, for example, an angular position of a rotor and/or of a shaft of the motor.

The motor position sensor for determining a position of the motor is optionally used for controlling the position of the actuator. Optionally, the motor position sensor is used to determine a position of the motor for a synchronisation with a position of the actuator. This is possible in particular because in the case of actuators, especially electromechanical actuators, there is a direct correlation between a position of the motor and a position of the actuator.

Optionally, a position of an electromechanical actuator (EMA) is controlled, in particular safely, wherein the actuator has a simplified architecture of the actuator electronics or a reduced sensor system.

Optionally, the motor position sensor is used to determine a position of the motor, such as an electric motor position sensor, in order to control and/or determine the position of the actuator.

Particularly in an actuator configured as an EMA, the position of the actuator can optionally be derived directly from the position of the motor, as the transmission ratio between the motor and the output or the actuating element of the actuator is constant and known.

Optionally, the control and/or determination is carried out in such a way that no sensor signal other than the sensor signal of the motor position sensor is used for the control and/or determination or that only a further sensor signal of a further sensor, in particular of an actuator position sensor, is used for the control and/or determination.

Optionally, it is provided that the control unit is a control unit, in particular only for the motor, and/or that the control and/or determination is performed, in particular only, by the control unit.

It is optionable that a reference position of the actuator and/or the motor is provided by a sensor, in particular an actuator position sensor, and/or a higher-level control system and/or that the reference position is determined by a reference run of the actuator.

The other sensor, in particular the actuator position sensor, is optionally configured to detect an absolute position of the actuator.

Optionally, a current position of the actuator, determined in particular by a monitor channel, is transmitted to the control unit via a data interface to determine the reference position.

In order to be able to derive an absolute position of the actuator from the position of the motor, it is optionable to determine a reference position, from which a deviation can be calculated.

Optionally, the reference position is “rigged” by means of a reference run.

Optionally, the reference position is provided by a separate sensor that is analysed in an evaluation unit other than the control unit. Communication between the control unit and the other evaluation unit is optionally possible.

Optionally, the reference position is determined by travelling to the stops of the actuator, wherein the current of the motor optionally increases when the stops of the actuator are reached and/or the actuator travels to a non-contact proximity switch.

Optionally, it is provided that the position of the actuator is determined, in particular by means of a load correction function, wherein the position is determined in particular by a sum of a product of a position of the motor and a transmission ratio and a product of a stiffness, in particular of a drive train, of the actuator and a measured variable proportional to a torque of the motor.

The stiffness of the drivetrain can also be a characteristic map that depends in particular on temperature and a measured variable proportional to the torque of the motor.

Optionally, the method comprises the following steps:
moving the actuator to a stop, wherein a current of the actuator motor is increased;
determining the stiffness, in particular of a drive train, of the actuator.

Optionally, it is provided that the position of the actuator is determined, in particular by means of a position correction function, wherein the position of the actuator is determined in particular by the sum of a determined position of the actuator and an actuator play of the actuator, wherein the sign of the play of the actuator is determined by means of state variables, in particular by means of a position and/or direction of rotation of the motor and/or by means of load information, in particular a current of the motor.

The actuator play can also be referred to as backlash. The actuator play can also be a characteristic map that depends in particular on temperature and a measured variable proportional to a torque of the motor.

Optionally, the method comprises the following steps:
rotating the motor in one direction until a movement of the actuator, in particular an actuating element, can be measured;
rotating the motor in a different direction until a movement of the actuator, in particular an actuating element, can be measured;
determining an actuator play of the actuator.

Optionally, the position of the actuator is determined by an observer.

Optionally, the position of the actuator determined by means of the motor position sensor is corrected by a position of the actuator determined by an actuator position sensor, which is transmitted in particular through a monitor channel.

Optionally, a current position of the actuator and/or the motor is stored before or after the actuator is switched off and is used as a reference position after the actuator is subsequently switched on, wherein a new reference position is optionally determined if the stored position of the actuator and/or the motor deviates from a measured position of the actuator and/or the motor.

Optionally, the motor position sensor is a resolver or an incremental encoder and/or not an absolute position sensor in relation to the actuator position.

The position of the actuator can be controlled, for example, via the position of the motor, e.g. by means of a resolver, an incremental encoder and/or a sensor that does not measure absolutely, i.e. a relative sensor, in relation to a reference position or starting position of the actuator.

The disclosure also relates to a system, in particular for an aircraft, with means, in particular an actuator with a control unit, a motor and a motor position sensor, which are configured to carry out a method according to the disclosure.

The components, in particular the control unit, the motor and the motor position sensor, of the actuator may be arranged in one structural unit. It is also possible that the components of the actuator are arranged in a distributed system in different structural units.

The motor is optionally an electric motor. The motor is optionally configured and arranged to move an actuating element of the actuator. A position, speed and/or acceleration of the actuator is optionally a position, speed and/or acceleration of the actuating element. The actuating element can be a linear actuator or a rotary actuator.

Optionally, the system comprises an actuator, wherein the actuator is an electromechanical or electrohydraulic actuator.

The disclosure also relates to an actuator for a system according to the disclosure.

Optionally, the system has an architecture that enables the use of simple actuators with reduced sensor technology without safety restrictions.

Optionally, the system has an actuator position control device with at least one EMA, which has at least one motor, a motor position sensor and a control unit, in particular a motor control unit.

Optionally, a position, e.g. a starting position, of the actuator is controlled by the motor control unit via the motor position.

Optionally, an absolute reference position is provided by a higher-level control system to initialise the control of the position, e.g. the starting position.

Optionally, a reference position is initialised by a reference movement to the end stops of the actuator. The initialisation sequence, e.g. the reference run, can be controlled either by the control unit or by a higher-level control system.

Optionally, a position, in particular an actual position, of the actuator is calculated using a load correction function with the following formula:

P_actuator=P_motor*r+k*i, wherein
P_actuator is the position of the actuator,
P_motor is the position of the motor,
k is the stiffness of a drive train of the actuator,
i is a measured variable proportional to the torque of the motor and
r is the transmission ratio of a gearbox between the motor and the actuating element of the actuator. The variable or parameter k can generally also be a characteristic map. The variable or parameter k can be a function of i and the temperature.

Optionally, it is provided that a position, in particular an actual position of the actuator, is calculated by means of a position correction function with the following formula:

P_actuator_2=P_actuator+sign*c, wherein
c is the actuator play or “backlash” of the actuator. Optionally, the sign is determined by state variables of the motor, such as the position of the motor, the direction of rotation of the motor and/or load information of the motor, in particular the current of the motor. The variable or parameter c can generally also be a characteristic map. The variable or parameter c can be a function of i and the temperature.

Optionally, the position P_actuator_2 is determined by an observer.

Optionally, the position of the actuator P_actuator determined by a monitor channel is made available to the control unit via a data interface for the initialisation of a position, e.g. a reference position.

Optionally, inaccuracies of a position, in particular an actual position, which can be caused, for example, by temperature or ageing effects, are corrected to a limited extent in relation to an assumed actual position via an actuator position signal provided by a monitor channel.

Alternatively or additionally, a method for calibrating the system with the following steps is provided:
1. actuator is moved to a stop;
2. motor current is increased;
3. the parameter k is determined, wherein k can be a stiffness of a drive train of the actuator.

Alternatively or additionally, a method for calibrating the system with the following steps is provided:
1. motor is rotated until a movement of the actuator, in particular an actuating element, can be measured
2. the motor is rotated in the other direction until a movement of the actuator, in particular an actuating element, can be measured at the output;
3. the parameter c is determined, wherein c can be an actuator play of the actuator.

Optionally, the current position of the actuator and the current position of the motor are stored after switching off the actuator and/or the system and are used as a reference position when starting the actuator and/or the system. If the stored position of the motor does not match a measured position of the motor, an initialisation is optionally requested.

The disclosure also relates to an aircraft, in particular an aeroplane, with a system according to the disclosure and/or an actuator according to the disclosure.

At this point, it should be noted that the terms “one” and “a” do not necessarily refer to exactly one of the elements, although this is one possible version, but can also refer to a plurality of the elements. Similarly, the use of the plural also includes the presence of the element in question in the singular and, conversely, the singular also includes a plurality of the elements in question. Furthermore, all of the features of the disclosure described herein may be claimed in any combination with each other or in isolation from each other.

Further advantages, features and effects of the present disclosure can be found in the following description of example embodiments with reference to the figures, in which like or similar components are denoted by the same reference signs. The figures show:

### BRIEF DESCRIPTION OF THE FIGURES

FIG. 1 to FIG. 2: schematic flow charts of an embodiment of a method according to the disclosure.

FIG. 3 to FIG. 5: schematic block diagrams of an embodiment of a system according to the disclosure.

FIG. 6: a schematic block diagram of an embodiment of a prior art system.

### DETAILED DESCRIPTION

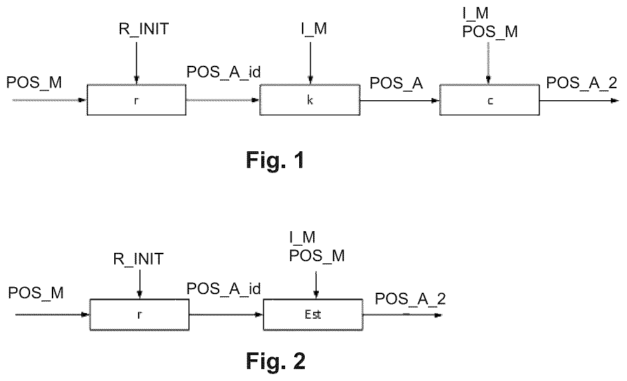

FIGS. 1 and 2 show a block diagram of a control routine, which may represent instructions stored in memory and coupled with a processor of a control unit (C) for controlling an actuator (A) and/or a higher-level control system as described herein. In FIG. 1, an ideal position of the actuator POS_A_id is determined in step r, taking into account a position of the motor POS_M and an initial reference position R_INIT.

In a step k, a position of the actuator POS_A is then determined from the ideal position of the actuator POS_A_id and the current of the motor I_M.

In step c, a position of the actuator POS_A_2 is then determined from the position of the actuator POS_A and the current of the motor I_M as well as a position of the motor POS_M.

In FIG. 2, an ideal position of the actuator POS_A_id is determined in step r, taking into account a position of the motor POS_M and an initial reference position R_INIT.

In a step Est, a position of the actuator POS_A_2 is then determined from the ideal position of the actuator POS_A_id and the current of the motor I_M as well as a position of the motor POS_M.

This means that several positions of the actuator POS_A_id, POS_A and/or POS_A_2 can be determined, in particular from a position of the motor POS_M and/or from another determined position of the actuator

The position of the actuator can be initialised with a signal from a monitor channel.

The accuracy of the control of the position of the actuator can be increased by using correction functions, such as a load correction function for correcting the influence of a stiffness, in particular of a drive train, of the actuator and/or a position correction function for correcting the influence of an actuator play of the actuator.

One or more parameters of the correction functions can be determined by initiation and/or calibration.

The determined position of the actuator can be corrected using information from a monitor channel.

The position of the actuator is controlled via feedback of the actuator position.

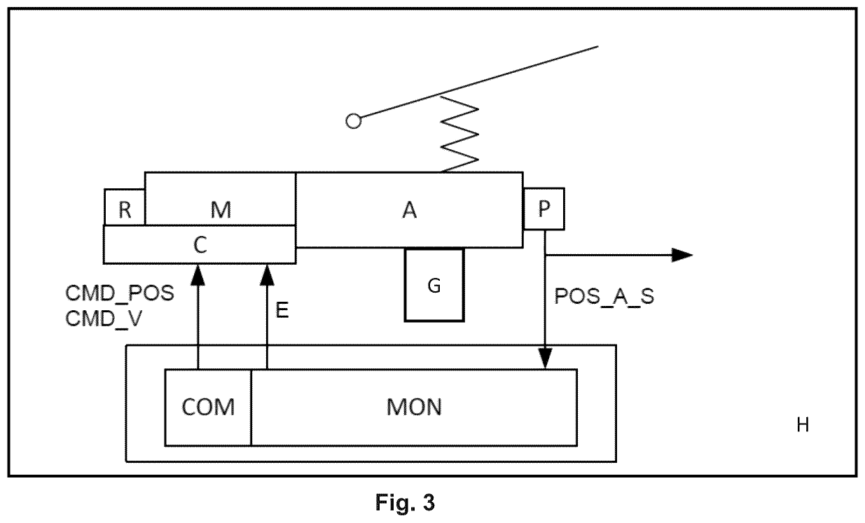

The system in FIG. 3 has an actuator with a motor M and an actuating element A. The system also has a motor position sensor R, a control unit C, an actuator position sensor P and a higher-level controller with a command channel COM and a monitor channel MON.

The actuating element A is configured and arranged to actuate and/or to move an element G of an aircraft H, such as a flap or a surface. The actuating element A can be moved linearly or rotationally, wherein the actuating element A can be a linear actuator or a rotary actuator.

The motor M can be controlled by a control unit C. A position of the motor M can be determined by a motor position sensor R.

The command channel COM can command a position and/or a speed for the actuator to the control unit C in the form of a signal CMD_POS or CMD_V.

The monitor channel MON can receive a sensor signal POS_A_S from the actuator position sensor P with information about the position of the actuator. The monitor channel can send a release signal or an “Enable” E to the control unit C.

The higher-level control system can be a “remote electronic unit” (REU) or a “flight control computer” (FCC) or a component thereof.

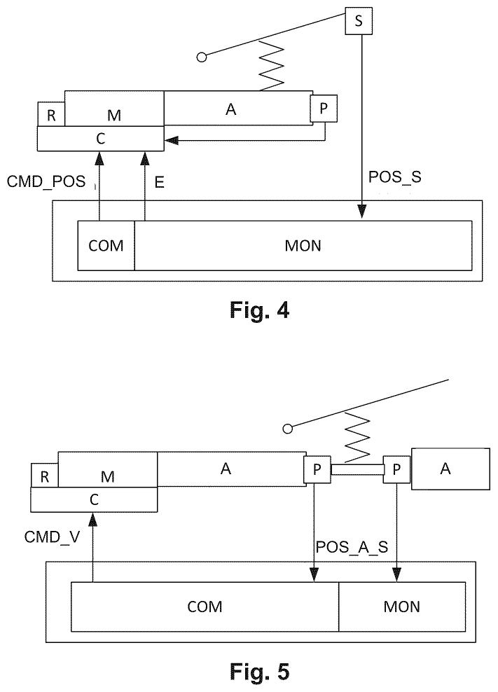

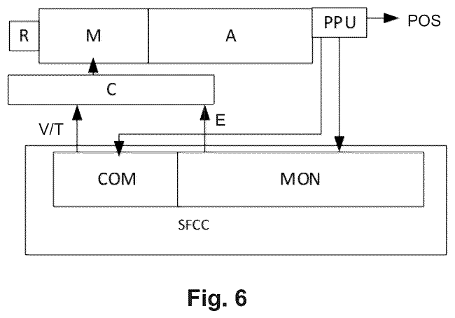

The system in FIG. 4 has an element position sensor S in addition to the system from FIG. 3. The sensor signal POS_S of the element position sensor S can be received by the monitor channel MON of the higher-level control unit and thus used to monitor the position and/or function of the first actuator. In contrast to the system in FIG. 3, the signal from the actuator position sensor P can be sent to the control unit C or received by the control unit C. The command channel COM can command a position for the actuator to the control unit C in the form of a signal CMD_POS.

In addition to the system in FIG. 3, the system in FIG. 5 has a second actuator with an actuating element A and an actuator position sensor P. The signal POS_A_S of the actuator position sensor P of the second actuator can be received by the monitor channel M and thus used to monitor the position and/or function of the first actuator. The command channel COM can command a speed for the actuator in the form of a signal CMD_V to the control unit C.

One advantage of the disclosure is that fewer sensors are required to control the actuators, thereby reducing complexity.

A further advantage of the disclosure is that a simplified architecture of the actuator electronics is possible.

A further advantage of the disclosure is that highly dynamic control is possible, since the control of the actuator position takes place in the control unit of the motor.

1. A method for controlling and/or determining a position of an actuator, wherein the actuator has a control unit, a motor and a motor position sensor for determining a position of the motor, wherein the control unit controls and/or determines the position of the actuator using the position of the motor and/or a sensor signal from the motor position sensor.

2. The method according to claim 1, wherein the control and/or determination is carried out in such a way that no sensor signal other than the sensor signal of the motor position sensor is used for the control and/or determination or that only a further sensor signal of a further sensor is used for the control and/or determination.

3. The method according to claim 2, wherein the control unit is a control unit and/or the control and/or determination is performed by the control unit.

4. The method according to claim 1, wherein a reference position of the actuator and/or the motor is provided by a sensor and/or a higher-level control system, and/or the reference position is determined by a reference run of the actuator.

5. The method according to claim 4, wherein a current position of the actuator, determined by a monitor channel, is transmitted to the control unit via a data interface to determine the reference position.

6. The method according to claim 1, wherein the position of the actuator is determined by means of a load correction function, wherein the position is determined by a sum of a product of a position of the motor and a transmission ratio and a product of a stiffness, of a drive train, of the actuator and a measured variable proportional to a torque of the motor.

7. The method according to claim 1, comprising the following steps:
moving the actuator to a stop, wherein a current of the actuator motor is increased;
determining the stiffness of a drive train of the actuator.

8. The method according to claim 1, wherein the position of the actuator is determined, by means of a position correction function, wherein the position of the actuator is determined by the sum of a determined position of the actuator and an actuator play of the actuator, wherein the sign of the play of the actuator is determined by means of state variables, by means of a position and/or direction of rotation of the motor and/or by means of load information, including a current of the motor.

9. The method according to claim 1, comprising the following steps:
rotating the motor in one direction until a movement of the actuator can be measured;
rotating the motor in a different direction until a movement of the actuator can be measured; and
determining an actuator play of the actuator.

10. The method according to claim 1, wherein the position of the actuator is determined by an observer.

11. The method according to claim 1, wherein the position of the actuator determined by means of the motor position sensor is corrected by a position of the actuator determined by an actuator position sensor, which is transmitted through a monitor channel.

12. The method according to claim 1, wherein a current position of the actuator and/or the motor is stored before or after the actuator is switched off and is used as a reference position after the actuator is subsequently switched on, wherein a new reference position is determined if the stored position of the actuator and/or the motor deviates from a measured position of the actuator and/or the motor.

13. The method according to claim 1, wherein the motor position sensor is a resolver or an incremental encoder and/or not an absolute position sensor in relation to the actuator position.

14. A system, with an actuator with a control unit, a motor and a motor position sensor, which are configured to carry out a method according to claim 1.

15. The system according to claim 14, wherein the system has an actuator, wherein the actuator is an electromechanical or electrohydraulic actuator.

16. An aircraft, with a system according to claim 14.

17. The method according to claim 1, wherein the actuator is of control surface of an aircraft.

18. The method according to claim 2, wherein the further sensor is an actuator position sensor.
